(19) United States
(12) Patent Application Publication
(10) Pub. No.: US 2026/0154161 A1
(43) Pub. Date: Jun. 4, 2026

(54) SYSTEM AND METHOD FOR MULTIPLE POINT-IN-TIME FILE SYSTEM EXPLORER FOR FILE SYSTEM COMPARISON

(71) Applicant: EON IO Ltd., Tel Aviv (IL)

(72) Inventors: Assaf Natanzon, Tel Aviv (IL); Ron Kimchi, Tel Aviv (IL); Benjamin Gruenbaum, Herzliya (IL); Lior Lev Tov, Bat Yam (IL); Ran Mizrachi, Mishmar Hashiva (IL)

(73) Assignee: EON IO Ltd., Tel Aviv (IL)

(21) Appl. No.: 18/965,859

(22) Filed: Dec. 2, 2024

(51) Int. Cl. G06F 11/14; G06F 16/11

(52) U.S. Cl. CPC G06F 11/1458; G06F 16/122

(57) ABSTRACT

In one embodiment, a method comprises receiving a request to view a portion of a first file system and a second file system; and generating a representation of a portion of a first file system and a second file system, the representation displayable in a file system explorer, wherein the representation includes a file at a file path, a first indication of one or more backups of the file for the first file system, and a second indication of one or more backups of the file for the second file system.

### TECHNICAL FIELD

This disclosure relates in general to the field of data backup and recovery and, more particularly, to a multiple point-in-time file system explorer for file system comparison.

### BACKGROUND

Cloud data backup is the process of creating and storing copies of data in a remote, cloud-based environment to ensure data availability, protection, and recovery in case of failure or data loss. While organizations may utilize traditional on-premises backups, cloud backups offer greater flexibility and scalability, allowing businesses to adjust storage as needed and access their data from anywhere with an internet connection. Cloud backups typically provide automated processes, encryption, and redundancy across multiple servers, enhancing both security and reliability. This ensures that businesses can recover their data quickly, minimizing downtime and mitigating the risk of data breaches or corruption. Cloud data backup may also be the most efficient way to backup workloads which are running natively in the cloud.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a block diagram of a cloud data backup environment, in accordance with any of the embodiments disclosed herein.

FIG. 2 illustrates a block diagram of a backend of a cloud backup service provider of the environment of FIG. 1, in accordance with any of the embodiments disclosed herein.

FIG. 3 illustrates a block diagram of a computing device of FIG. 1, in accordance with any of the embodiments disclosed herein.

FIG. 4 illustrates an example data backup sequence, in accordance with any of the embodiments disclosed herein.

FIG. 5 illustrates a storage backup log for a multiple point-in-time file system explorer, in accordance with any of the embodiments disclosed herein.

FIG. 6 illustrates a multiple point-in-time file system explorer, in accordance with any of the embodiments disclosed herein.

FIG. 7 illustrates a flow for updating a storage backup log for a multiple point-in-time file system explorer, in accordance with any of the embodiments disclosed herein.

FIG. 8 illustrates a flow for providing a multiple point-in-time file system explorer, in accordance with any of the embodiments disclosed herein.

FIG. 9 illustrates a storage backup log for a multiple point-in-time file system explorer for ransomware mitigation, in accordance with any of the embodiments disclosed herein.

FIG. 10 illustrates a multiple point-in-time file system explorer for ransomware mitigation, in accordance with any of the embodiments disclosed herein.

FIG. 11 illustrates a multiple point-in-time file system explorer with filtering capabilities for ransomware mitigation, in accordance with any of the embodiments disclosed herein.

FIG. 12 illustrates a flow for updating a storage backup log for a multiple point-in-time file system explorer for ransomware mitigation, in accordance with any of the embodiments disclosed herein.

FIG. 13 illustrates a flow for providing a multiple point-in-time file system explorer for ransomware mitigation, in accordance with any of the embodiments disclosed herein.

FIG. 14 illustrates a multiple point-in-time file system explorer for file system comparison, in accordance with any of the embodiments disclosed herein.

FIG. 15 illustrates storage backup logs for a multiple point-in-time file system explorer for file system comparison, in accordance with any of the embodiments disclosed herein.

FIG. 16 illustrates a multiple point-in-time file system explorer for file system comparison including an option to hide common files, in accordance with any of the embodiments disclosed herein.

FIG. 17 illustrates a flow for providing a multiple point-in-time file system explorer for file system comparison, in accordance with any of the embodiments disclosed herein.

### DETAILED DESCRIPTION OF EXAMPLE EMBODIMENTS

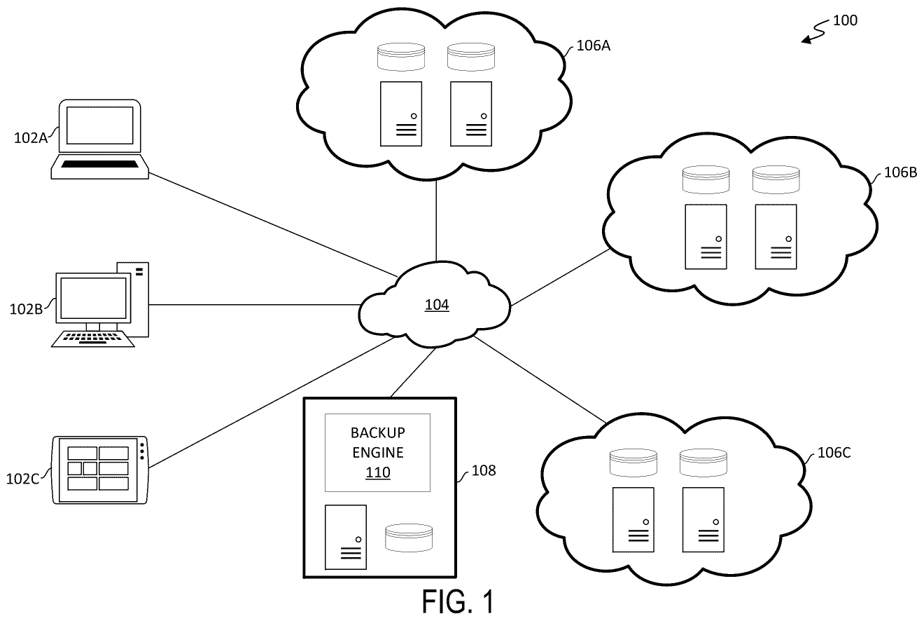

FIG. 1 illustrates a block diagram of a cloud data backup environment 100, in accordance with any of the embodiments disclosed herein. An organization (e.g., any one or more users associated with each other) may utilize any number of storage collections with file systems that include data (e.g., directories and files) accessed by users associated with the organization. The users may interact with the data using computing devices 102 (e.g., 102A, 102B, 102C).

The data may be stored (temporarily or persistently) at a site owned or leased by the organization (e.g., “on premises”), at another location (e.g., owned or managed by a cloud service provider), or at multiple locations. The data of an organization may be backed up in the cloud, e.g., within a backend 106 (e.g., 106A, 106B, 106C) of a cloud backup service provider, across multiple backends of the same cloud backup service provider, at one or more backends of a different cloud backup service provider, at another suitable location (e.g., at a local site or device of the organization), or any combination thereof (e.g., some data may be backed up at backend 106A, other data may be backed up at backend 106B, and some data may be backed up at a local site). In some instances, the organization may also have data that is not backed up (but rather stored locally, in the cloud, or otherwise).

When a user is navigating within a file explorer in a file system that has been backed up (e.g., in the cloud, in on-premises storage, in a portable hard drive, etc.), the view of the directories and files within the file explorer are typically limited to a single point-in-time. For example, the user may view the current directories and files or may view the directories and files that are backed up by a particular instance of a series of backups. Accordingly, it may be difficult for a user to understand the history of the directories and files without manually navigating through each backup. Moreover, a file may have been deleted at some point and if the user does not know the name of the file (or the backup utility does not support searching by file name across the different backups), the user may have to manually browse multiple backups in order to locate the file.

Various embodiments provide a multiple point-in-time file system explorer that provides a view of a file system at multiple points in time simultaneously. Through this explorer, a user may be provided a wholistic view of the evolution of one or more file systems. In some embodiments, a reference point-in-time may be specified (e.g., by the user) and the file system explorer may display the directories and files from the perspective of the reference point-in-time. Directories and files that were (or are) in existence at the reference point-in-time may be displayed in a first format (e.g., a standard format). However, the file system explorer may also display directories and files that were deleted prior to the reference point-in-time and/or directories and files that were created after the reference point-in-time. In some instances, these directories and files may be formatted differently from the directories and files that are in existence at the reference point-in-time to enable the user to easily detect changes that occurred prior to and/or after the reference point-in-time. Thus, a user may browse the file system at multiple points in time simultaneously, greatly enhancing the ability of the user to locate desired files or directories that have changed over time.

Some embodiments provide a multiple point-in-time file system explorer for ransomware mitigation. Ransomware is a type of malicious software (malware) that encrypts a victim's files or locks them out of their system, rendering the data or system inaccessible. The attacker then demands a ransom from the victim to restore access to the data or system. Ransomware may target a computing device (e.g., 102) using any suitable attack vectors, such as phishing emails, malicious websites, remote desktop protocol, or software vulnerabilities. While regular backups of a storage collection may mitigate the risk of losing files to ransomware, if the ransomware encrypts files over a long period of time (e.g., in order to avoid immediate detection), the last clean backup may be too old or it may be difficult for the user to identify clean versions of the files that the user would like to restore (e.g., the clean versions may be spread out among numerous backups at different points in time). The user may spend an inordinate amount of time choosing the correct backup for each file and verifying that the file is not corrupt.

Various embodiments provide a multiple point-in-time file system explorer that displays identifiers of files as well as the point-in-time of the backup of the last known good copy of the file if the file is likely to be corrupt. A file system may include files with corresponding different points in time if the files were corrupted at different times. Such a file system may allow a user to quickly identify and restore uncorrupted versions of files that have become corrupt via ransomware (or other malicious or harmful means). Thus, in some embodiments, the multiple point-in-time file system explorer presents at least a portion of a file system to the user from the point of view of the last backup (or other point of time of another selected backup), but for files that are detected as corrupt, the explorer may present the latest good point in time for those files.

Some embodiments provide a multiple point-in-time file system explorer that provides a view of two or more file systems simultaneously (e.g., from the same computing system or from different computing systems). In some instances, it may be useful to compare two version of a particular file system, such as a previous backup against a current version of a file system, a file system on a machine that has been in operation against a file system from a machine with a fresh installation of an operating system and/or other applications (e.g., to find corrupted system files), a file system from a machine that has restored a backup and then made changes against the backup itself, or a backup that was performed by a first backup product against one or more backups performed by a second backup product (e.g., one of the backup solution embodiments described herein), among other use cases. In various embodiments, the multiple point-in-time file system explorer may include an option to hide common files in order to facilitate easier identification of files that are different between the two or more file systems.

Various embodiments may provide one or more technical advantages such as faster identification of files or directories, decreased usage of computing and/or network resources (e.g., power, bandwidth) when searching for, accessing, and/or restoring files or directories, or other technical advantages.

In the depicted embodiment, the cloud data backup environment 100 includes a data backup and search system 108. The data backup and search system 108 may provide any suitable features of the embodiments of the multiple point-in-time file system explorer described herein. In some embodiments, the data backup and search system 108 may include a backup engine 110 that is to detect initiations of backups and, in response, record changes of the data collection backed up by the backup in a storage backup log (e.g., as described below). The backup engine 110 may also perform the actual backup as well and/or may communicate with other logic to perform the backup. In various embodiments, backup engine 110 may be included, in whole or in part, within the data backup and search system 108, within a backend 106, at a computing device 102, at another suitable location within cloud data backup environment 100, or at any combination thereof. The backup engine 110 may be implemented by one or more computing devices, such as computing device 300 described below.

In various embodiments, any of the features of the multiple point-in-time file system explorer or a subset thereof may be performed by any other suitable logic, such as computing devices within one of the backends 106, by a computing device 102 (e.g., through a web application or native application that interfaces with the data backup and search system 108), by other suitable logic, or by any suitable combination of these and/or the data backup and search system 108.

The data backup and search system 108 may receive requests from one or more computing devices 102 over network 104 to backup data and in response may initiate backups in one or more of backends 106 (or other locations) as well as store data representing changes across the various backups at different points in time to provide the multiple point-in-time file system explorer. The data backup and search system 108 may also interact with the computing devices 102 to provide the multiple point-in-time file system explorer. For example, the data backup and search system 108 may receive input from a user browsing backed up data in a multiple point-in-time file system explorer on a computing device 102 and may update the view provided to the user based on the input from the user and the data representing the changes in the backups at the multiple points in time. The data backup and search system 108 may also be operable to restore (or at least initiate restoration of) data from backups based on requests from users made in the multiple point-in-time file system explorer.

Data backup and search system 108 may include any suitable number of computing devices to perform the functions described herein. In a particular embodiment, the data backup and search system 108 may comprise a cluster of nodes (e.g., physical or virtual machines) in a Kubernetes environment, although any suitable computing environment may be used to implement the data backup and search system 108. The data backup and search system 108 may include and/or manage a plurality of accounts, where a particular account may be associated with (e.g., owned or controlled by) a particular organization. Data used to provide the multiple point-in-time file system explorer (e.g., storage backup logs) for a particular organization may be stored in the account owned by that organization. In various embodiments, the data backup and search system 108 may be separate from the backends 106 or could be implemented (at least in part) within one of the backends 106.

Computing devices 102 may include any electronic computing device operable to receive, transmit, process, and store any appropriate data. In various embodiments, computing devices 102 may be mobile devices or stationary devices. As examples, mobile devices may include laptop computers, tablet computers, smartphones, personal digital assistants, and other devices capable of connecting (e.g., wirelessly) to network 104 while stationary devices may include desktop computers or other devices that are not easily portable. Computing devices 102 may include a set of programs such as operating systems (e.g., Microsoft Windows, Linux, Android, Mac OSX, Apple iOS, UNIX, or other operating system), applications, and other software-based programs capable of being run, executed, or otherwise used by the respective devices. A computing device may include at least one graphical display and user interface allowing a user to view and interact with applications and other programs of the computing device to perform operations associated with one or more data (e.g., searching for data, modifying data contents, reading data contents, initiating data backups, etc.).

FIG. 1 also depicts a network 104 that couples the computing devices 102, backends 106, and data backup and search system 108 together. The network 104 may transport communications between computing devices 102, the various backends 106, and the data backup and search system 108.

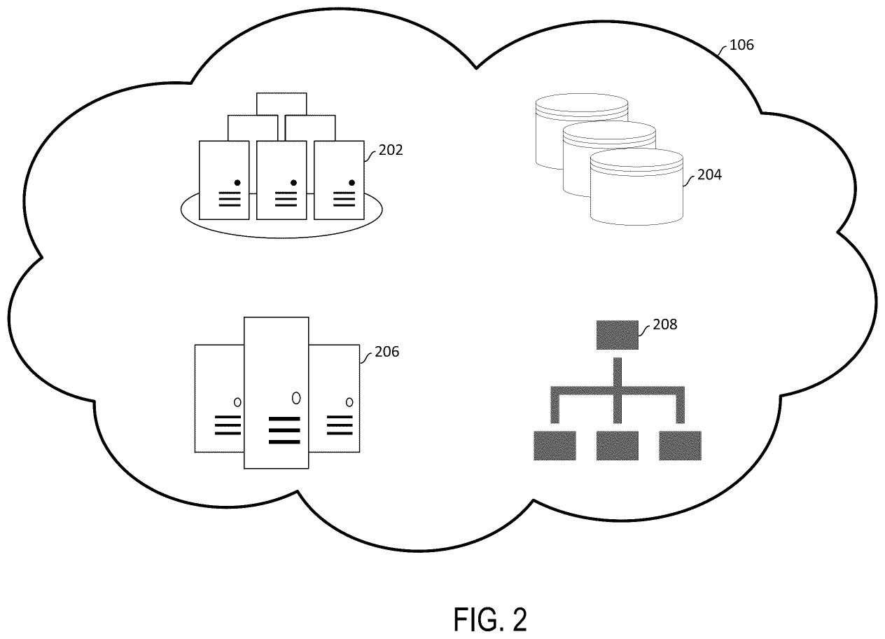

FIG. 2 illustrates a block diagram of a backend 106 of a cloud backup service provider of the environment of FIG. 1, in accordance with any of the embodiments disclosed herein. Backend 106 may include various computing systems to provide services (including data backup services) to various organizations. In the embodiment depicted, backend 106 includes compute resources 202, storage resources 204, operations computing systems 206, and networking resources 208.

Compute resources 202 may include hardware components used to provide cloud services, such as general-purpose processors (e.g., central processing units (CPUs), server processors, accelerated processing units (APUs), controllers), specialized processors (e.g., graphics processing units (GPUs), application-specific integrated circuits (ASICs), digital signal processors (DSPs), field programmable gate arrays (FPGAs), neural network processing units (NPUs), data processor units (DPUs), controller cryptoprocessors (specialized processors for cryptographic algorithms)), or accelerators (e.g., graphics accelerators, compression accelerators, artificial intelligence accelerators), or other hardware components.

Storage resources 204 may provide the storage and retrieval of data (e.g., data (including backups) or associated data). Storage resources 204 may include hardware, such as hard disk drives, solid-state drives, tape storage, or other suitable mechanisms for storing data. Storage resources 204 may store any suitable data in any suitable format(s). For example, storage resources 204 may provide object, block, or file storage.

Operations computing systems 206 may include any suitable computing systems to manage the various operations of the backend, such as coordination of incoming and outgoing communications; allocation of compute, storage, and networking resources; monitoring of usage; application deployment; enforcement of security (e.g., identity and access management (IAM), encryption and key management, intrusion detection), and other management tasks.

Networking resources 208 may include any suitable hardware or software to facilitate communication among compute resources 202, storage resources 204, and/or other cloud resources of the backend. Networking resources 208 may include, e.g., routers, switches, firewalls, load balancers, gateways, edge devices, network interface cards, and other suitable networking hardware.

The compute resources 202, storage resources 204, and networking resources 208 may be used to provide compute services to clients of the service provider, such as virtual machines, containers, bare metal servers, or serverless computing.

In various embodiments, a backend 106 is managed by a third party. For example, a backend 106 may be deployed using a cloud service such as Amazon Web Services, Microsoft Azure, or Google Cloud Platform. A backend 106 may provide services to organizations using any suitable service model, such as infrastructure as a service (IaaS), platform as a service (PaaS), or software as a service (SaaS), or combinations thereof.

In IaaS, on-demand access is provided to essential information technology (IT) infrastructure, such as servers, storage, and networking, over a virtual interface. Users do not need to manage or maintain physical infrastructure, as it is hosted and managed by the cloud service provider. While the provider handles the underlying hardware and maintenance, users retain control over operating systems, storage, and applications they deploy. This eliminates the need for organizations to manage on-premises infrastructure, offering flexibility and scalability.

In PaaS, a development and deployment environment is provided, including the necessary infrastructure and software tools, for creating and managing applications. Users can develop and run cloud-based applications without managing the underlying infrastructure, such as servers, networks, and storage. PaaS is typically accessed on a pay-as-you-go basis and allows users to focus on application deployment and management, while the cloud provider handles the infrastructure and software maintenance.

In SaaS, users access cloud-based applications provided and maintained by a service provider. Instead of installing software locally, users access the applications via the web or application programming interface (API) on a subscription basis. In this model, the service provider oversees the hardware, software, middleware, and security, eliminating the need for end users to manage or update the software themselves.

An organization may utilize one or more backends 106 to provide data backup for the organization. Data backup is the process of creating a copy of the data that can be used to restore the data in case of data loss, corruption, or other disasters. Backups are essential for data protection, disaster recovery, and ensuring business continuity.

Various types of backups may be performed on the data of an organization. In a full backup, a complete copy of the entire data collection covered by the backup is saved in the backup storage. This is the most comprehensive type of backup but can be time consuming and storage intensive. In an incremental backup, only the data that has changed since the last backup on the data collection (either full or incremental) is saved in the backup storage. This reduces the amount of data to be backed up and speeds up the backup process. In a differential backup, all of the data that has changed in the data collection since the last full backup is saved in the backup storage. This is faster than a full backup but can grow in size over time until the next full backup.

An organization may utilize various backup strategies (and could utilize different backup strategies for different data collections). For example, in a full backup strategy, full backups are regularly performed. This strategy may be suitable for small data where backup time and storage size are not significant concerns. In an incremental backup strategy, a full backup may be performed periodically (e.g., weekly) and incremental backups are performed more often (e.g., daily). This reduces backup time and storage requirements. In a differential backup strategy, a full backup is performed periodically (e.g., weekly) and differential backups are performed more often (e.g., daily). This strategy provides a balance between backup time and storage. In a mixed strategy, various types of strategies (e.g., full, incremental, and transaction log backups) may be combined to optimize backup and recovery times.

An organization may utilize any suitable data backup tool to implement their desired backup strategies and to create data backups that are stored on a backend 106 or other location. Various such tools include, e.g., rsync (a command-line utility for Unix-based systems that synchronizes files and directories between two locations), tar (a Unix utility used to create archive files), Bacula, Amanda, Veeam, and Acronis.

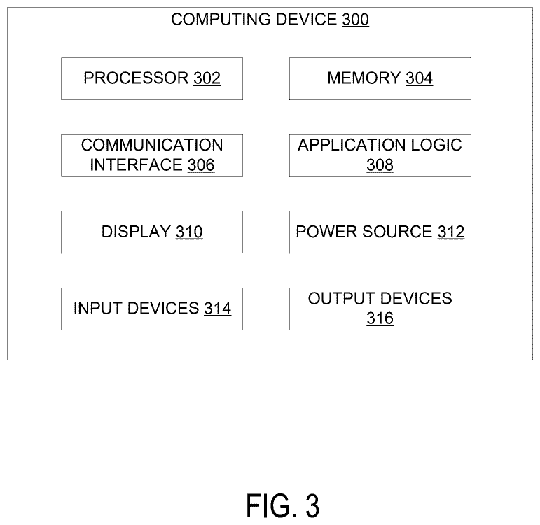

FIG. 3 illustrates a block diagram of a computing device 300, in accordance with any of the embodiments disclosed herein. One or more computing devices 300 (or portions or alternatives thereof) may be used to implement a computing device 102, one or more portions of data backup and search system 108, or one or more portions of backends 106. As used in this document, the term computing device is intended to encompass any suitable processing device. A computing device 300 may be operable to receive, transmit, process, store, or manage data and information associated with cloud data backup environment 100.

In the depicted embodiment, computing device 300 includes one or more processors 302, memories 304, communication interfaces 306, application logic 308, display 310, power source 312, input devices 314, and output devices 316, among other hardware and software. These components may work together in order to provide any suitable functionality described herein.

A processor 302 may be any suitable computing device, resource, or combination of hardware, stored software and/or encoded logic operable to provide, either alone or in conjunction with other components of computing device 300, the functionality of the computing device. In particular embodiments, computing device 300 may utilize multiple processors to perform the functions described herein. In various embodiments, processor 302 may include one or more general-purpose processors (e.g., CPUS, server processors, APUs, controllers), specialized processors (e.g., GPUs, general-purpose GPUs, ASICs, DSPs, FPGAs, NPUs, DPUs, controller cryptoprocessors (specialized processors for cryptographic algorithms)), or accelerators (e.g., graphics accelerators, compression accelerators, artificial intelligence accelerators).

A processor can execute any type of instructions to achieve the operations detailed in this specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an application specific integrated circuit (ASIC) that includes digital logic, software, code, electronic instructions, or any suitable combination thereof.

Memory 304 may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory 304 may store any suitable data or information utilized by a computing device 300, including software embedded in a (e.g., non-transitory) computer readable medium, and/or encoded logic incorporated in hardware or otherwise stored (e.g., firmware). Memory 304 may also store the results and/or intermediate results of the various calculations and determinations performed by processor 302.

Communication interface 306 may be used for the communication of signaling and/or data between computing devices and one or more networks and/or network nodes coupled to a network or other communication channel. For example, communication interface 306 may be used to send and receive network traffic such as data packets. Each communication interface 306 may send and receive data and/or signals according to a distinct standard such as an LTE, IEEE 802.11, IEEE 802.3, or other suitable standard. In some instances, communication interface 306 may include antennae and other hardware for transmitting and receiving radio signals to and from other devices in connection with a wireless communication session over one or more networks.

Application logic 308 may include logic providing, at least in part, the functionality of the computing device. In a particular embodiment, the logic of a computing device 300 may include software (e.g., a web browser, an application, an operating system, etc.) that is executed by processor 302. However, “logic” as used herein, may include but not be limited to hardware, firmware, software and/or combinations of each to perform a function(s) or an action(s), and/or to cause a function or action from another logic, method, and/or system. In various embodiments, logic may include a software controlled microprocessor, discrete logic (e.g., an application specific integrated circuit (ASIC)), a programmed logic device (e.g., a field programmable gate array (FPGA)), a memory device containing instructions, combinations of logic devices, or the like. Logic may include one or more gates, combinations of gates, or other circuit components. Logic may also be fully embodied as software.

Display 310 may include one or more embedded or connected (e.g., via a wired or wireless connection) external visual indicators, such as a computer monitor, a touchscreen display, a liquid crystal display (LCD), a light-emitting diode display, or a flat panel display.

Power source 312 may include one or more energy storage devices (e.g., batteries or capacitors) and/or circuitry for coupling components of the computing device 300 to an energy source separate from the computing device 300 (e.g., alternating current line power).

An input device 314 may accept input from a source external to the computing device 300. Examples of input devices 314 may include an image capture device, keyboard, cursor control device, touchscreen, and an audio device (e.g., microphone), to name a few.

An output device 316 may output signals based on information provided by computing device 300. Examples of output devices 316 include an audio device (e.g., a speaker), an audio codec, a video codec, a printer, a transmitter for providing information to other devices, a storage device, to name a few.

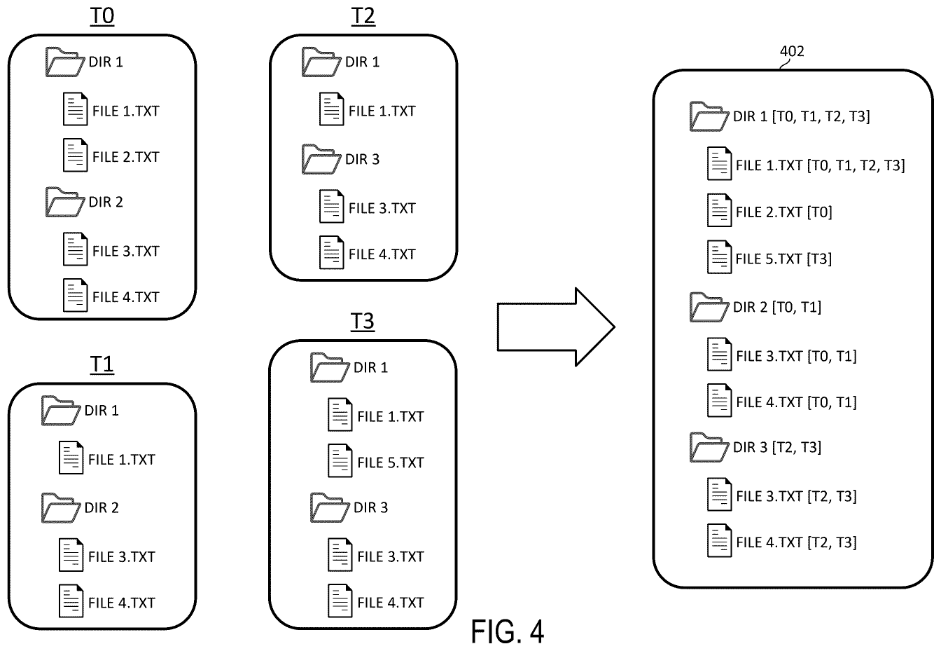

FIG. 4 illustrates an example data backup sequence, in accordance with any of the embodiments disclosed herein. This sequence shows the evolution of files and directories of a particular path and a multiple point-in-time file system explorer 402.

When a first backup of a storage collection is performed at time T0, the path of the source storage device that is to be backed up (e.g., the root directory) includes a first directory DIR 1 which includes a first file FILE 1.TXT and a second file FILE 2.TXT as well as a second directory DIR 2 which includes a third file FILE 3.TXT and a fourth file FILE 4.TXT.

In between time T0 and the next storage backup performed at time T1, FILE 2.TXT is deleted at the source storage device. Then, prior to the next storage backup performed at time T2, the directory DIR 2 is renamed to DIR 3. Finally, a fifth file FILE 5.TXT is added to the directory DIR 1 prior to the storage backup performed at T3.

Responsive to the backups, the data backup and search system 108 may store associations between the files and directories present during each of the backups and the points in time of the backups. These stored associations may enable provision of the multiple point-in-time file system explorer. Thus, for directory DIR 1, the multiple point-in-time file system explorer 402 indicates that DIR 1 and FILE 1.TXT were present in the backups at times T0, T1, T2, and T3, FILE 2.TXT was present at time T0, and FILE 5.TXT was present at T3. As depicted, DIR 2 and its files FILE 3.TXT and FILE 4.TXT were present at times T0 and T1. DIR 3 and its files FILE 3.TXT and FILE 4.TXT were present at times T2 and T3.

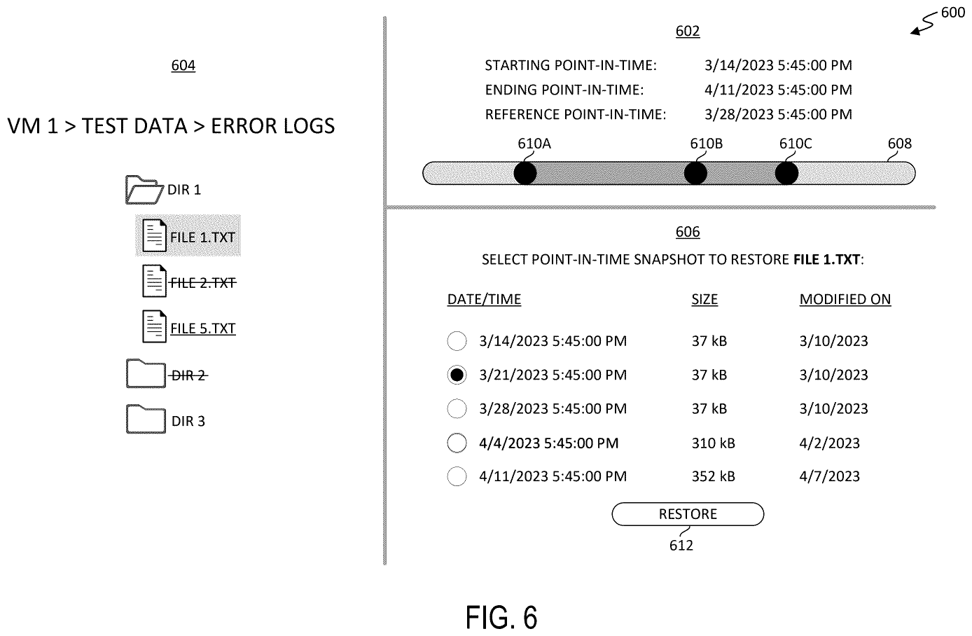

As depicted, the multiple point-in-time file system explorer 402 may be displayed in a format in which the directory names and file names are displayed along with indications of the points in time of the backups that include the directories and files. In some embodiments, the directories and files for all available backups may be presented within the multiple point-in-time file system explorer 402 and selecting a directory or file (e.g., with a right click of a mouse or other user activity) may result in a display of indications of the backups that include the selected directory or file (e.g., the indication may include the date and/or time of the backups or other temporal indication distinguishing the backups). An alternative interface for the multiple point-in-time file system explorer is described in connection with FIG. 6.

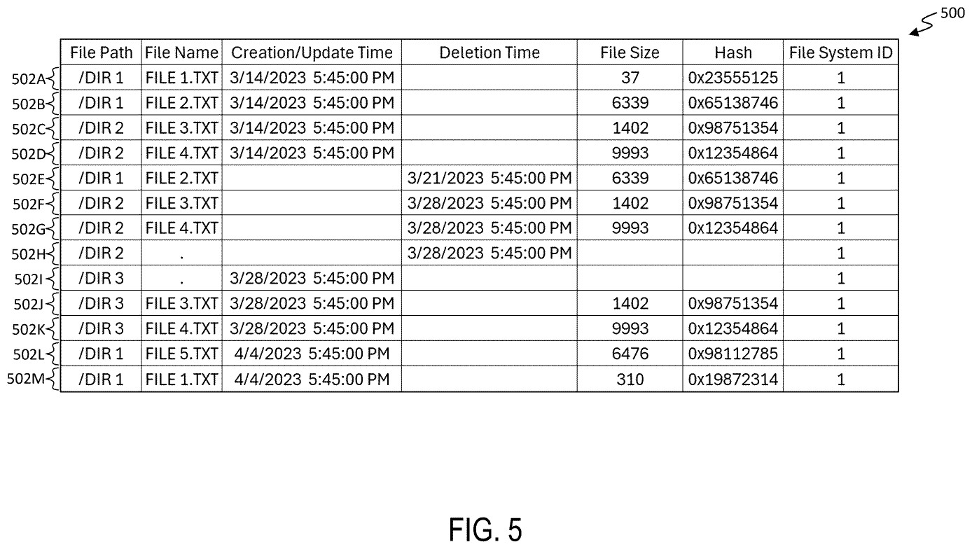

FIG. 5 illustrates a storage backup log 500 for a multiple point-in-time file system explorer, in accordance with any of the embodiments disclosed herein. In some embodiments, the storage backup log 500 may be stored at and/or maintained by data backup and search system 108, a backend 106, one or more computing devices 102, or other suitable logic. The storage backup log 500 may be updated each time a storage backup is performed. For example, in conjunction with performing a storage backup, the storage backup log 500 may be updated with changes that have been made to the files and directories covered by the backup relative to the most recent backup.

In this example, the storage backup log 500 is stored in a table of a relational database (e.g., a SQL database) in which each record 502 (e.g., row) of the storage backup log 500 corresponds to a change to a file or directory in the storage collection covered by the backup. A table may be a structured collection of related data organized in rows and columns. Each record (also referred to as a row) may represent a single entry in the table, while each column (also referred to as field or attribute) may represent a specific attribute of the data.

The records 502 in FIG. 5 track the sequence of FIG. 4. The log 500 includes columns including file path, file name, creation/update time, deletion time, file size, hash, and file system identifier (ID). In other embodiments, one or more of these columns may be omitted and/or the storage backup log 500 may include additional columns (e.g., a last modified date column indicating the date/time the file or directory was last modified at the source or a created column indicating the date/time the file or directory was created at the source).

The file path may be a string that describes the location of a file or directory within a file system. It specifies the route or path to access the file, beginning from the root directory to the specific file or directory. The file path may be an absolute file path (e.g., a complete path from the root of the file system to the target file or directory) or a relative file path (e.g., a partial path starting from a directory other than the root directory). In the records 502 shown in FIG. 5, the file paths all start from a root directory represented by the “/” character.

The file name may be a specific name of a file and is typically expressed as a string (e.g., an alphanumeric string). The file name may also include an extension based on the type of the file (in this case “.TXT” for each file referenced in the storage backup log 500). When a record 502 corresponds to a directory (e.g., as is the case with records 502H and 502I), a default value (e.g., null, “.”, etc.) may be stored in the file name field.

The creation/update time may include a date and/or time at which the file or directory was created or updated (if the change indicated by the record was a creation or update of a file or directory, otherwise this field may be null or some other predetermined value). In other embodiments, separate columns could be used for creation time and updated time. The deletion time may include a date and/or time at which the file or directory was deleted (if the change indicated by the record was a deletion of a file or directory, otherwise this field may be null or some other predetermined value).

The file size includes a size of the file or directory (e.g., in kilobytes or other unit). The file sizes for the directories may be null (as shown) or may also be included in this field (not shown).

The hash is a string (e.g., of a fixed length) of characters generated from the contents of the file using a hash function (e.g., a message digest algorithm, a secure hash algorithm, a checksum, or other suitable hash function). The hash serves as a unique fingerprint or identifier for that file and may typically be used by the backup engine 110 to distinguish between different versions of the same file.

The file system ID represents an ID of a file system to which the file or directory belongs. In some instances, a backup of a storage collection (e.g., of one or more computing systems) may encompass multiple file systems. Accordingly, the file system ID allows differentiation between the files and directories of the various file systems.

In particular embodiments, the storage backup log 500 may be dedicated to a particular backup series of the same storage collection. For example, the storage backup log 500 may be dedicated to backups of a particular machine, volume, drive, or other storage collection made at different points in time. In other embodiments, the storage backup log 500 could be used for multiple different backup series of different storage collections (e.g., of different machines, drives, etc.). In such a case the storage backup log 500 could include an additional field that includes an identifier of the storage collection that is being backed up through the backup series (e.g., a machine name, network address, etc.). In various embodiments, the storage backup log 500 may include any other suitable fields, such as a file creation time, a file last modified field, or other suitable fields.

When a storage collection is scanned in conjunction with a backup, each change in the storage device is identified and a record is made in the storage backup log 500 for the change. Such changes may include, e.g., a creation of a file or directory, a deletion of a file or directory, an update to contents of a file, a change in the title of a file or directory, and a change in the location of a file or directory. In various embodiments, a change in the location or title of a file or directory may be recorded in two records of the storage backup log 500, wherein a first record indicates a deletion of the file or directory in the previous location or with the previous title and a second record indicates a creation of the file or directory in the new location or with the new title.

Referring jointly to FIGS. 4 and 5, a first backup is performed on 3/14/2023 at 5:45:00 PM (e.g., “T0”). If this backup is the first backup performed on the storage collection, then all files and directories may be detected as new and a record may be created for each file and directory that is backed up (where each record shows a creation of a file or directory). If the backup is not the first backup, then records 502 will be created for changes detected relative to the most recent backup on the storage device. In this instance, creation of FILE 1.TXT and FILE 2.TXT within /DIR 1 is detected and results in generation of records 502A and 502B. Similarly, creation of FILE 3.TXT and FILE 4.TXT within /DIR 2 is also detected and results in generation of records 502C and 502D. Each of records 502A-D includes a time of creation (3/14/2023 5:45:00 PM) equal to the time the backup is performed and no value (or a null value) in the deletion time column. These records also include respective file sizes and hash values as well as the same file system ID.

A second backup is performed on 3/21/2023 at 5:45:00 PM (e.g., “T1”). The only change detected in this backup relative to the first backup is deletion of FILE 2.TXT. Accordingly, record 502E is added to the log to capture the deletion.

A third backup is performed on 3/28/2023 at 5:45:00 PM (e.g., “T2”). In this backup, the changes relative to the second backup include the changing of the name of DIR 2 to DIR 3. Accordingly, records 502F and 502G recording the deletion of FILE 3.TXT and FILE 4.TXT within /DIR 2 are generated. Additionally, record 502H recording the deletion of /DIR 2 is also generated. Record 502I recording the creation of /DIR 3 is generated and records 502J and 502K recording the creation of FILE 3.TXT and FILE 4.TXT within /DIR 3 are also generated to complete the records capturing the renaming of /DIR 2 to /DIR 3.

A fourth backup is performed on 4/4/2003 at 5:45:00 PM (e.g., “T3”). In the fourth backup, the changes relative to the third backup include the creation of FILE 5.TXT within /DIR 1 and an update to FILE 1.TXT within /DIR 1. Record 502L captures the addition of FILE 5.TXT and record 502M captures the update to FILE 1.TXT. As evidenced by records 502A and 502M, the file size of FILE 1.TXT has changed from 37 kB to 310 kB and the hash value has also changed.

Storing the storage backup log 500 in a relational database may simplify provision of the multiple point-in-time file system explorer (although in various embodiments the storage backup log 500 may be stored in any suitable format). For example, when a user has selected a file path to view in the multiple point-in-time file system explorer 402, the storage backup log 500 may be searched (e.g., using one or more SELECT queries) using filters for the file path (and potentially other filters for the creation/update time and the deletion time) in order to obtain a list of files and directories across multiple points in time (that correspond to different backup versions). For example, all of the files that were created before or during a time span or a point-in-time specified by the user may be returned by one or more searches of the storage backup log 500 for display in the multiple point-in-time file system explorer 402. A search may also be made for files or directories that were deleted during the time span or at the point-in-time so that such files or directories may be marked as deleted in the multiple point-in-time file system explorer 402. Although not shown, in some embodiments, the records may be kept in storage backup log 500 by lexicographical order by file path (e.g., to improve query times).

FIG. 6 illustrates a multiple point-in-time file system explorer 600, in accordance with any of the embodiments disclosed herein. The multiple point-in-time file system explorer 600 may include any suitable characteristics of multiple point-in-time file system explorer 402 or vice versa.

In this embodiment, the multiple point-in-time file system explorer 600 may be provided (e.g., displayed) to a user of a computing device 102 through a web application (e.g., accessed through a web browser executed by a computing device 102), through a native application executed by the computing device 102, or by other suitable means.

The multiple point-in-time file system explorer 600 includes a point-in-time selector portion 602, a file system explorer portion 604, and a restoration portion 606. The point-in-time selector portion 602 allows the user to specify one or both of a reference point-in-time and a time range (defined by a starting point-in-time and an ending point-in-time). In the embodiment depicted, a slider bar 608 allows a user to slide one or more nodes 610 (e.g., 610A, B, C) across a range between the point-in-time of the earliest backup and the point-in-time of the most recent backup of a particular storage collection. In this embodiment, node 610A may select a starting point-in-time, node 610B may select a reference point-in-time, and node 610C may select an ending point-in-time. Each of these points in time are displayed above the slider bar 608. In other embodiments, the point-in-times may be specified via any other interface (e.g., a calendar interface, a text entry field, a selection from a list of available points in time, etc.).

The results shown in the file system explorer portion 604 may be based on the reference point-in-time and/or the time range. In one embodiment, a reference point-in-time is selected. The results shown in the file explorer portion 604 are formatted based on the reference point-in-time. For example, current files and directories in existence in the backup performed at the reference point-in-time are displayed in a first format, files and directories deleted prior to the reference point-in-time are displayed in a second format, and files and directories created after the reference point-in-time are displayed in a third format. The formats may be different from each other so as to allow current (e.g., files or directories in existence in the backup performed at the reference point-in-time), deleted, and future files and directories to be distinguished from each other. For example, in the embodiment depicted, the names of the current files and directories (e.g., in existence in the backup made at 3/28/2023 5:45:00 PM) are shown in a standard font, the names of the file (FILE 2.TXT) and directory (DIR 2) that were deleted prior to the reference point-in-time are shown with strikeout formatting, and the name of the file (FILE 5.TXT) created after the reference point-in-time is shown with underline formatting. In various embodiments, any other suitable formatting may be used. For example, the names and/or icons representing the directories or directories may be displayed in different colors and/or may be highlighted using different colors or effects.

In some instances, a reference point-in-time is specified but a time range is not specified. In such instances, the time range for determining which deleted files and directories and future files and directories to display in file explorer portion 604 may include the points of time of all of the available backups for the storage collection. However, when a range is specified, the deleted files and directories and future files and directories displayed in file explorer portion 604 may be filtered based on the range. For example, files and directories deleted prior to the starting point-in-time as well as files and directories created after the ending point-in-time may be omitted from the file explorer portion 604.

When a file or directory is selected, hovered over by a mouse pointer, or receives other suitable interaction from the user, any suitable information associated with the file or directory may be displayed. In the embodiment depicted, FILE 1.TXT is selected as indicated by its background highlighting. Responsive to this selection, restoration portion 606 is displayed. Restoration portion 606 includes a list of the storage backups that include the selected file and the point-in-times of those backups. In various embodiments, the restoration portion 606 may be constructed (e.g., by backup engine 110 or other suitable logic) based on the entries of the storage backup log 500 for the file. Radio buttons are present next to the points in time allowing the user to select one of the backups from which the file may be restored (e.g., to its original location or to another location selected by the user), e.g., responsive to selection of button 612. The restoration portion 606 also displays the size of each file backup as well as the date on which the file was last modified at the source location. The date the file was last modified may be different from the date of the backup.

In some instances, only unique versions of the file are shown to the user in the multiple point-in-time file system explorer 600 (e.g., where the unique versions may be determined by entries for the file stored in the storage backup log 500). Thus, in the embodiment depicted, the versions available in the backups on 3/21/2023 and 3/28/2023 may be omitted in an alternative embodiment.

In other embodiments, any suitable information may additionally or alternatively be displayed in the multiple point-in-time file system explorer 600 responsive to the selection of a file or directory, whether displayed within restoration portion 606 or within another portion of the multiple point-in-time file system explorer 600. For example, the hashes or version numbers associated with the different versions of the files or the time the file or directory was created at the source may be displayed in some embodiments.

Multiple point-in-time file system explorer 600 may also allow for various filtering options to be applied to the files and directories that are displayed by the 600. For example, the user may be able to filter files or directories based on the creation time, updated time, deleted time, file size, or other suitable criteria.

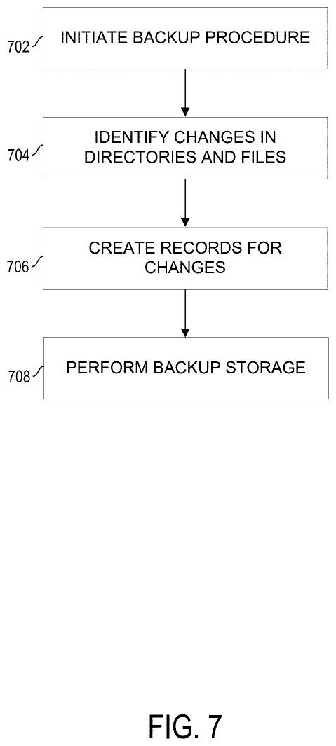

FIG. 7 illustrates a flow for updating a storage backup log for a multiple point-in-time file system explorer, in accordance with any of the embodiments disclosed herein. Operations of the flow may be performed by the backup engine 110, a backend 106, one or more computing devices 102, other suitable logic, and/or a combination thereof.

At 702, a backup procedure is initiated. The backup procedure may be initiated in response to reception of a storage backup request from a user of a computing devices 102, a scheduled backup for a previously entered backup request, or some other trigger. A storage backup request may identify a data collection comprising files and directories that are to be backed up. The collection may include at least a portion of at least one file system. The collection may include all or a portion of the files and directories stored by one or more physical machines, virtual machines, storage drives, server pools, or other storage collection of one or more computing devices.

At 704, the data collection is scanned to identify changes in files and directories since the last backup was performed on the data collection. Changes may include, e.g., addition or deletion of files or directories, updating of names or contents of files or directories, or changes in location of files or directories.

At 706, records are created for the changes. The records may be added to a storage backup log (e.g., 500 or a variation thereof) that is kept for backups of the data collection.

At 708, the data collection is backed up. For example, a full, incremental, or differential backup may be performed. In some instances, the backup engine 110 may perform the backup (e.g., by copying files to a backend 106). In other instances, some other logic (e.g., any suitable backup tool) may perform the backup.

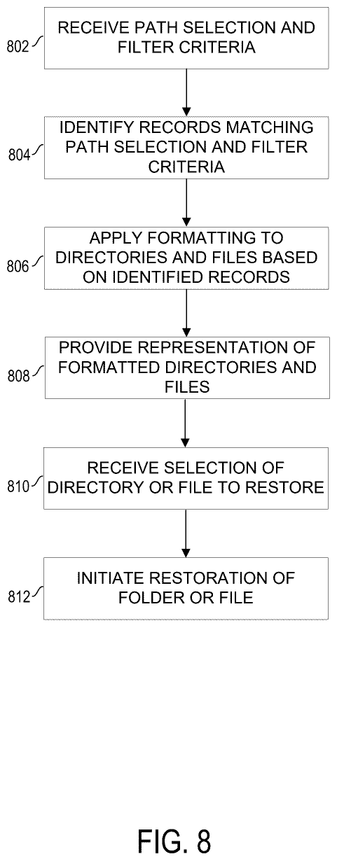

FIG. 8 illustrates a flow for providing a multiple point-in-time file system explorer, in accordance with any of the embodiments disclosed herein. Operations of the flow may be performed by the data backup and search system 108, backup engine 110, a backend 106, one or more computing devices 102, other suitable logic, and/or a combination thereof.

At 802, a path selection and filter criteria are received. For example, a user may utilize a multiple point-in-time file system explorer (e.g., 402, 600, or variant thereof) executed on a computing device 102 to select a file path to view. The user may also specify one or more filter criteria. The filter criteria may include one or more of a reference point-in-time, a starting point-in-time, and ending point-in-time, creation time, updated time, deleted time, file size, or other suitable criteria.

At 804, records matching the path selection and the filter criteria are identified. In various embodiments, the records may be identified from a storage backup log 500. For example, these records may include information specifying which files and directories were included at that path in backups performed at various point-in-times. The information may also indicate that some of these files or directories were deleted prior to a reference point-in-time or created after the reference point-in-time.

At 806, formatting is applied to one or more directories and/or files based on the identified records. For example, a first format may be applied to files and directories existing at the reference point-in-time, a second format may be applied to files and directories that had been deleted prior to the reference point-in-time, and a third format may be applied to files and directories that were created after the reference point-in-time.

At 808, a representation of the formatted directories and files is provided. For example, the representation of the formatted directories and files may be provided by the data backup and search system 108 or other logic of cloud data backup environment 100 to a computing device 102 in any suitable format allowing the data backup and search system 108 to display the multiple point-in-time file system explorer. For example, the representation may be provided in HyperText Markup Language, JavaScript Object Notation, eXtensible Markup Language, JavaScript, or other suitable format. Similarly, such a representation may also be provided by circuitry of a computing device 102 (e.g., that receives the representation from data backup and search system 108 or generates a displayable representation based on information received from data backup and search system 108) to other circuitry of computing device 102 for display by the computing device 102.

At 810, a selection of a directory or a file to restore is received. For example, a user may select a version of the directory or file to restore from the multiple point-in-time file system explorer (e.g., by selecting the particular point-in-time of one of the backups of the directory or file). At 812, restoration of the directory or file is initiated. For example, the data backup and search system 108 may communicate with a backend 106 to cause the file or directory to be restored to the source or other location specified by a user.

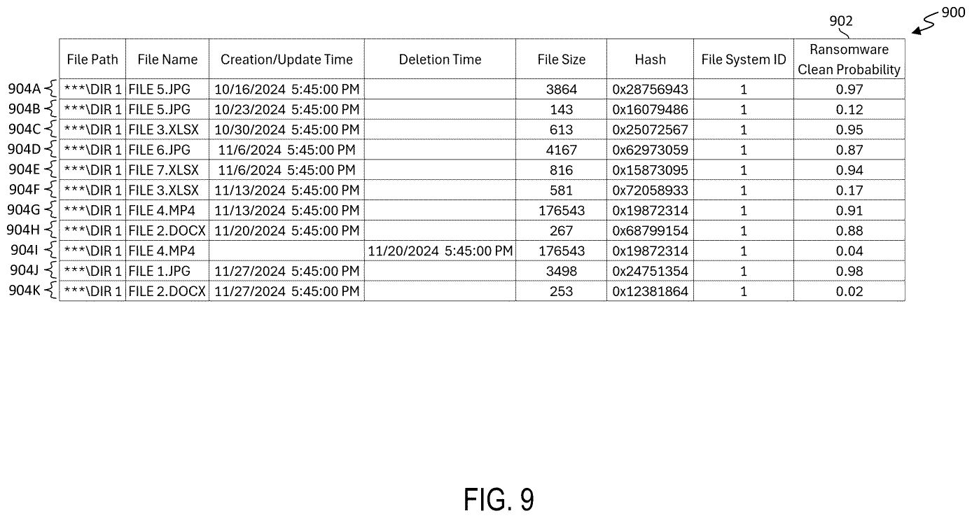

FIG. 9 illustrates a storage backup log 900 for a multiple point-in-time file system explorer for ransomware mitigation, in accordance with any of the embodiments disclosed herein. The storage backup log 900 may have any suitable characteristics of storage backup log 500, but in this embodiment the records also include values for a likelihood of whether the file is corrupt, embodied in FIG. 9 as a ransomware clean probability.

The ransomware clean probability 902 is a likelihood that the file referenced in that record is not corrupt (e.g., encrypted by ransomware). In this embodiment, the ransomware clean probability 902 ranges between 0 and 1, with 0 indicating full probability that the file is corrupt and 1 indicating no probability that the file is corrupt. Other embodiments may use any suitable scoring system for the likelihood of corruption.

The ransomware clean probability 902 for a file may be determined, e.g., by the backup engine 110, other logic of data backup and search system 108, computing device 102, or other suitable logic of cloud data backup environment 100 in any suitable manner. For example, the 902 may be calculated based on the amount of change in the file relative to the last time the file was backed up, the amount of entropy of the file, a determination of whether the format of the content of the file matches the expected format of the file type extension (e.g., if the extension is . docx, a check is made to see whether the file conforms with typical . docx formatting), whether the file extension has changed (while the remainder of the file title remains the same), abnormal file size, whether a directory of the file includes a ransom note, whether the file is an initial version of a file, or other suitable determinations.

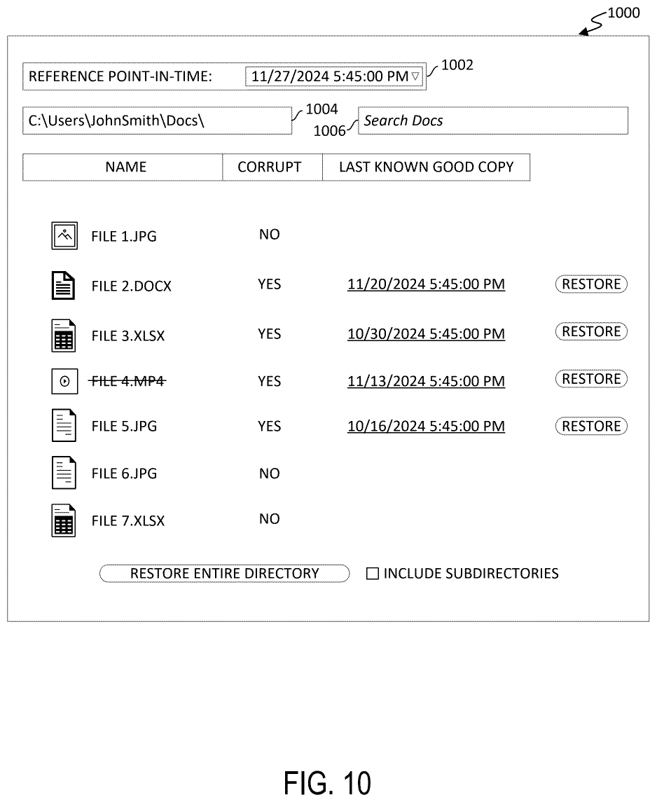

Storage backup log 900 includes a plurality of records that each have a ransomware clean probability 902. In some embodiments, some records may omit a ransomware clean probability 902. For example, if the record denotes a deletion of a file the ransomware clean probability 902 may be omitted. As an alternative (and as shown in the embodiment), a record corresponding to a deletion may include a ransomware clean probability 902 that indicates the likelihood that the deletion was caused by ransomware or other malicious software. For explanatory purposes, the first portion of the file paths in the record are abbreviated as ***. The records shown may be a portion of the records in the storage backup log 900 and are all for files within a directory at “C:\Users\JohnSmith\Docs\” (as shown in FIG. 10).

In various embodiments, a threshold value for the ransomware clean probability 902 may be used to determine whether the system will consider a file to be corrupt or not corrupt. The threshold may be set by the data backup and search system 108 or other suitable logic. In some instances, a user of a computing device 102 or an administrator of an organization may specify the threshold to be used (e.g., by entering it into an interface displayed by a computing device and transmitting it over a network to the data backup and search system 108).

In other embodiments, multiple thresholds may be used to classify the likelihood that the file is corrupt. For example, the data backup and search system 108 may use various thresholds to differentiate between highly likely to be corrupt, probably corrupt, maybe corrupt, probably not corrupt, and highly unlikely to be corrupt (and the multiple point-in-time file system explorer 1000 could display such indications). While the focus herein is on a system that performs a binary determination as to whether a file is corrupt based on a single threshold for a ransomware clean probability, the embodiments herein may be adapted to multiple levels of likelihood a file is corrupt or the determination of whether the file is corrupt may be made in any other suitable manner based on any of the factors listed above with respect to determining the ransomware clean probability or other suitable factors. For the examples of FIGS. 9-11 herein, a threshold of 0.2 will be used, wherein a score under 0.2 results in the file system explorer treating the file as corrupt and a score over 0.2 results in the file system explorer treating the file as not corrupt (in other words a good copy).

Record 904A indicates that in a first backup on 10/16/2024, FILE 5.JPG is created (or updated). The ransomware clean probability of this record is 0.97, indicating that this file is not corrupt.

Record 904B indicates that in a second backup on 10/23/2024, FILE 5.JPG is updated. The ransomware clean probability of this record is 0.12, indicating that this file is corrupt. Thus, the file may have been affected by ransomware between the first backup and the second backup.

Record 904C indicates that in a third backup on 10/30/2024, FILE 3.XLSX is created (or updated). The ransomware clean probability of this record is 0.95, indicating that this file is not corrupt.

Record 904D indicates that in a fourth backup on 11/6/2024, FILE 6.JPG is created (or updated). The ransomware clean probability of this record is 0.87, indicating that this file is not corrupt.

Record 904E indicates that in the fourth backup, FILE 7.XLSX is created (or updated). The ransomware clean probability of this record is 0.94, indicating that this file is not corrupt.

Record 904F indicates that in a fifth backup on 11/13/2024, FILE 3.XLSX is updated. The ransomware clean probability of this record is 0.17, indicating that this file is corrupt.

Record 904G indicates that in the fifth backup, FILE 4.MP4 is created (or updated). The ransomware clean probability of this record is 0.91, indicating that this file is not corrupt.

Record 904H indicates that in a sixth backup on 11/20/2024, FILE 2.DOCX is created (or updated). The ransomware clean probability of this record is 0.88, indicating that this file is not corrupt.

Record 904I indicates that in the sixth backup, FILE 4.MP4 is deleted. In this embodiment, a ransomware clean probability score is assigned to this record. In this embodiment, the score may be based on the probability that the deletion was caused by malicious software such as ransomware. This score may be determined based on any suitable factors, such as when the file was deleted, how the file was deleted (e.g., what process initiated the deletion), or other suitable factors. In this instance, the ransomware clean probability for the deletion is 0.04, indicating that the deletion was caused by malicious software.

Record 904J indicates that in a seventh backup on 11/27/2024, FILE 1.JPG is created (or updated). The ransomware clean probability of this record is 0.98, indicating that this file is not corrupt.

Record 904K indicates that in the seventh backup, FILE 2.DOCX is updated. The ransomware clean probability of this record is 0.02 indicating that this file is corrupt.

FIG. 10 illustrates a multiple point-in-time file system explorer 1000 for ransomware mitigation, in accordance with any of the embodiments disclosed herein. The multiple point-in-time file system explorer 1000 may include any suitable characteristics of multiple point-in-time file system explorers 402 or 600.

The multiple point-in-time file system explorer 1000 includes an interface 1002 for entering a reference point-in-time. The reference point-in-time may function similarly to the reference point-in-time described earlier in connection with FIG. 6. In some embodiments, the reference point-in-time may default to the point-in-time of the most recent backup, but a different point-in-time may be selected by the user.

Multiple point-in-time file system explorer 1000 also includes an interface 1004 for a user to enter a file path and a search interface 1006 to enter search terms. The multiple point-in-time file system explorer 1000 displays files and/or directories matching the file path and/or the search terms entered by the user. In some embodiments, the information to display in multiple point-in-time file system explorer 1000 may be determined based on a backup log, such as storage backup log 900.

In the embodiment depicted, the multiple point-in-time file system explorer 1000 displays the names of the files and their extensions (matching the file path and/or search terms) as well as an indication of whether the latest version of the file that has been backed up is corrupt (e.g., in the backup occurring at the reference point-in-time or in the most recent backup in which the file was backed up prior to the reference point-in-time). If a file is detected as corrupt, an indication of the last known good copy (e.g., a point-in-time of a backup) of the file is also displayed.

As captured in the storage backup log 900, record 904J indicates that FILE 1.JPG is not corrupt. Record 904K indicates that the latest version of FILE 2.DOCX is corrupt. Record 904H is the most recent record for a creation or update of FILE 2.DOCX that indicates a good copy of the file, therefore the point-in-time of that record is listed in multiple point-in-time file system explorer 1000 as the last known good copy of FILE 2.DOCX.

Record 904F indicates that the latest version of FILE 3.XLSX is corrupt. Record 904C is the most recent record for a creation or update of FILE 3.XLSX that indicates a good copy, therefore the point-in-time of that record is listed in multiple point-in-time file system explorer 1000 as the last known good copy of FILE 3.XLSX.

FILE 4.MP4 was deleted prior to the backup on 11/27/2024 at the reference point-in-time, but may be displayed in the multiple point-in-time file system explorer 1000 based on the determination that the deletion may have been caused by malicious software (as indicated by the low ransomware clean probability 902 of record 904I. Because FILE 4.MP4 was not in existence as of the reference point-in-time, it may be shown in a format that is different from the other files. In this embodiment, the file is shown in strikethrough to indicate the prior deletion. In other embodiments, any suitable formatting may be used (e.g., a different color, one or more different effects, etc.). The multiple point-in-time file system explorer 1000 also shows the point-in-time of the last known good copy of the deleted file, which was 11/13/2024 as indicated by record 904G.

Record 904B indicates that the latest version of FILE 5.JPG is corrupt, but record 904A indicates a good copy of FILE 5.JPG, therefore the point-in-time of that record is listed in multiple point-in-time file system explorer 1000 as the last known good copy of FILE 5.JPG.

The most recent record 904D for FILE 6.JPG indicates that FILE 6.JPG is not corrupt. Similarly, the most recent record 904E for FILE 7.XLSX indicates that FILE 7.XLSX is not corrupt. Accordingly, these files are both shown as not corrupt by multiple point-in-time file system explorer 1000.

In some embodiments, if a file is detected as corrupt, but no good copy is available in any of the backups, the multiple point-in-time file system explorer 1000 may indicate such in the display (e.g., through an informative message, a different formatting of the file name, or other suitable means). Thus, a user may be informed and may have the opportunity to browse one or more versions of the file to verify whether the versions are all indeed corrupt.

In various embodiments, the multiple point-in-time file system explorer 1000 may include any other suitable information for the files at the reference point-in-time and/or the point-in-time of the last known good copies. For example, the size or date of last modification of either (or both) the corrupt file and the last known good copy may be displayed.

In some embodiments, the multiple point-in-time file system explorer 1000 may include links (e.g., hyperlinks) to either version or both versions of the file at the reference point-in-time and at the time of the last known good copy, to enable the user to access the versions of the file to determine whether they are indeed corrupt.

The multiple point-in-time file system explorer 1000 also includes buttons next to the individual indications of the points in time of the last known good copies of the corrupt files. When one of these buttons is selected, a process to restore the corresponding file is initiated. The file may be restored in any suitable manner. In one embodiment, any versions of the file that have been backed up after the point-in-time of the last known good copy may be deleted from the backups. Additionally or alternatively, the corresponding records in the storage backup log 900 may be deleted so that as of the reference point-in-time, the last known good copy is referenced as the version in existence at the reference point-in-time. In various embodiments, the file(s) may be restored to their original location (e.g., at the source) or downloaded to a different location.

In the embodiment depicted, the multiple point-in-time file system explorer 1000 also includes an option to restore multiple files with a single selection. For example, a user may initiate restoration of the entire directory (with an option to include the restoration of last known good copies of corrupt files in the subdirectory of the current directory or just to include the files of the current directory). In some embodiments, the user may additionally or alternatively have an option to restore all corrupt files in the storage collection covered by the backups (e.g., an entire file system or a portion thereof).

In some instances, the multiple point-in-time file system explorer 1000 may include an option that when selected displays the various points in time of backups of a corrupt file so that the user may browse the versions of the file to determine which versions are corrupt and which version should be restored. The user may then select one of these versions and the system may initiate restoration of the file.

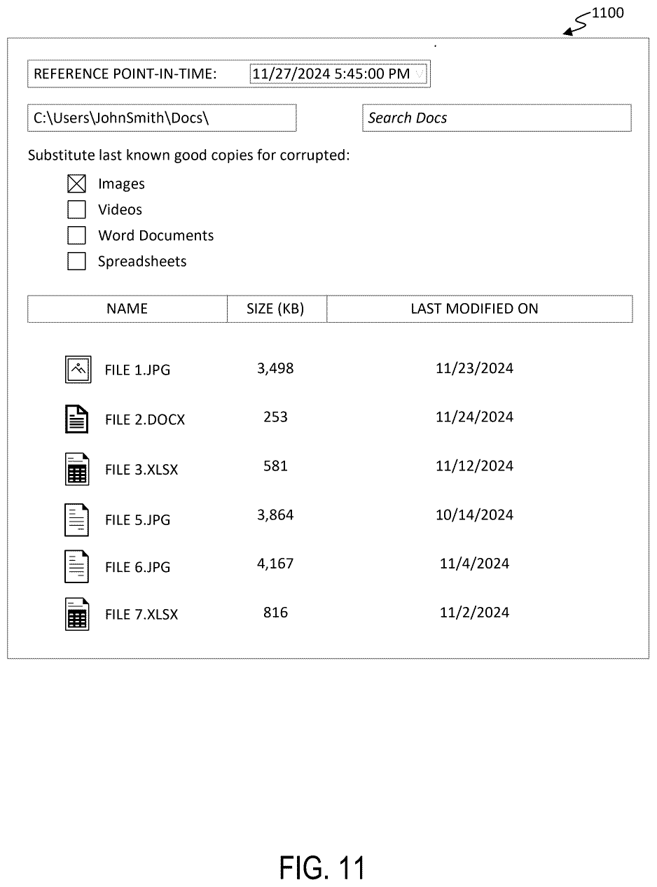

FIG. 11 illustrates a multiple point-in-time file system explorer 1100 with filters for ransomware mitigation, in accordance with any of the embodiments disclosed herein. The multiple point-in-time file system explorer 1100 may include any suitable characteristics of multiple point-in-time file system explorers 402, 600, or 1000.

In this embodiment, multiple point-in-time file system explorer 1100 includes a filter section 1102, enabling a user to select the types of files for which the last known good copies will be displayed if the latest version of the file is corrupt. The filters may be of a general type as shown. For example, selection of images may result in filtering for various types of images, such as .JPG, .PNG, .BMP, .PNG, etc., selection of word documents may result in filtering for various types of word documents, such as .DOCX., .DOC., .RTF., etc. Additionally or alternatively, a user may specify specific file type extensions for the filtering.

The files displayed in the multiple point-in-time file system explorer 1100 are based on the reference point-in-time, the file path, and the selected filtering. In this embodiment, the user has selected “Images” as the filtering option, such that for any image files within the file path C:\Users\JohnSmith\Docs\ that are detected as corrupt, the last known good copy of that file from a prior backup will be substituted for the version of the file at the reference point-in-time.

In the embodiment depicted, the latest versions (at the reference point-in-time) of the file types that are not selected in the filtering portion are all shown, regardless of whether the file is detected as corrupt or not. For the image files, the files in the path are each checked to see whether the version of the file at the reference point-in-time is corrupt or not. If the file is not corrupt, the version of the file in existence at the reference point-in-time is displayed by the 1100. If the file is corrupt, the most recent good copy of the file at a point-in-time prior to the reference point-in-time is displayed in place of the version of the file at the reference point-in-time.

In the embodiment depicted, FILE 1.JPG, FILE 5.JPG, and FILE 6.JPG are the files within the path that are images. The versions of FILE 1.JPG and FILE 6.JPG at the reference point-in-time are not corrupt (as indicated by records 904J and 904D) and thus the versions of these files as of the reference point-in-time are displayed. The most recent version of FILE 5.JPG as of the reference point-in-time is detected as corrupt as indicated by record 904B, so the version of FILE 5.JPG corresponding to the record 904A is displayed in the multiple point-in-time file system explorer 1100.

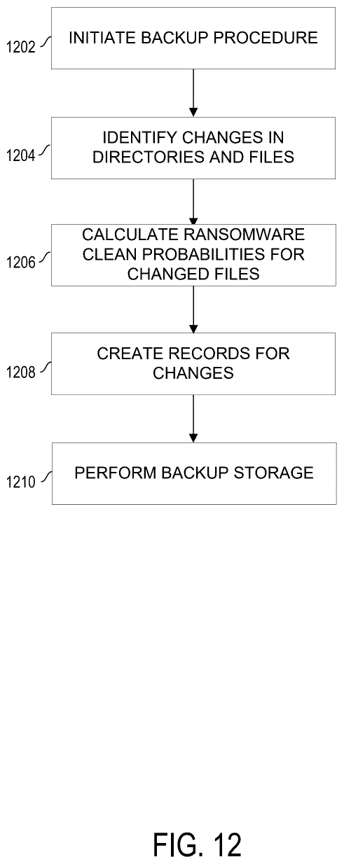

FIG. 12 illustrates a flow for updating a storage backup log for a multiple point-in-time file system explorer for ransomware mitigation, in accordance with any of the embodiments disclosed herein. Operations of the flow may be performed by the data backup and search system 108, the backup engine 110, a backend 106, one or more computing devices 102, other suitable logic, and/or a combination thereof.

At 1202, a backup procedure is initiated (e.g., in a manner similar to that described above with respect to operation 702). At 1204, the data collection is scanned to identify changes in files and directories since the last backup was performed on the data collection (e.g., in a manner similar to that described above with respect to operation 704).

At 1206, ransomware clean probabilities (or other suitable indications of the probabilities that the respective files are corrupt) are calculated for the files that were identified as new or updated at 1204. These probabilities may be calculated in any suitable manner, such as that described above.

At 1208, records are created for the changes. The records may be added to a storage backup log (e.g., 900 or a variation thereof) that is kept for backups of the data collection. The records may include the ransomware clean probabilities.

At 1210 the data collection is backed up (e.g., in a manner similar to that described above with respect to operation 708).

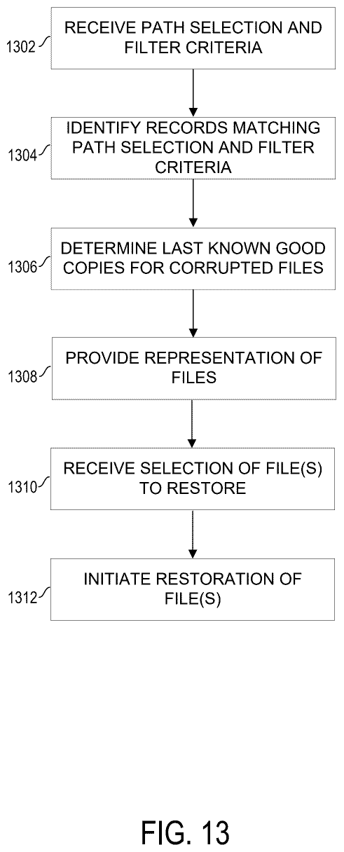

FIG. 13 illustrates a flow for providing a multiple point-in-time file system explorer for ransomware mitigation, in accordance with any of the embodiments disclosed herein. Operations of the flow may be performed by the data backup and search system 108, backup engine 110, a backend 106, one or more computing devices 102, other suitable logic, and/or a combination thereof.

At 1302, a path selection and filter criteria are received. For example, a user may utilize a multiple point-in-time file system explorer (e.g., 1000, 1100, or variant thereof) executed on a computing device 102 to select a file path to view and/or file search terms. The user may also specify a reference point-in-time. In various embodiments, the user could specify other filtering criteria such as a starting point-in-time of backups to be searched, a file creation time or range, a file updated time or range, a file deleted time or range, a file size or size range, or other suitable criteria that may be used to limit the results displayed by the file system explorer.

At 1304, records matching the path selection and the filter criteria are identified. In various embodiments, the records may be identified from a storage backup log 900. For example, these records may include information specifying which files and directories were included at that path at the reference point-in-time. These records may also indicate whether the files corresponding to the records are likely to be corrupt.

At 1306, the point in time of the backup of the last known good copy is determined for each of the files that are deemed to be corrupt (e.g., that have a ransomware clean probability below a threshold value). For example, the storage backup log 900 may be searched to identify the most recent version of the file prior to the reference point-in-time that has an acceptable ransomware clean probability (e.g., above a threshold value).

At 1308, a representation of the files is provided. For example, the representation of the files may be provided by the data backup and search system 108 or other logic of cloud data backup environment 100 to a computing device 102 in any suitable format allowing the computing device 102 to display the multiple point-in-time file system explorer. For example, the representation may be provided in HyperText Markup Language, JavaScript Object Notation, eXtensible Markup Language, JavaScript, or other suitable format (e.g., pixel data for a graphic representation sent to a GPU). The representation may include, for example, names of the files, any suitable information about the files (e.g., sizes, date/time last modified, etc.) and the points in time of the last known good copies of the files for files that are corrupt at the reference point-in-time.

At 1310, a selection of one or more files to restore is received. For example, a user may select an option to restore the last known good copy of one or more of the corrupt files. At 1312, restoration of the selected file(s) is initiated. For example, the data backup and search system 108 may communicate with a backend 106 to cause the file(s) to be restored to the source or other location specified by a user.

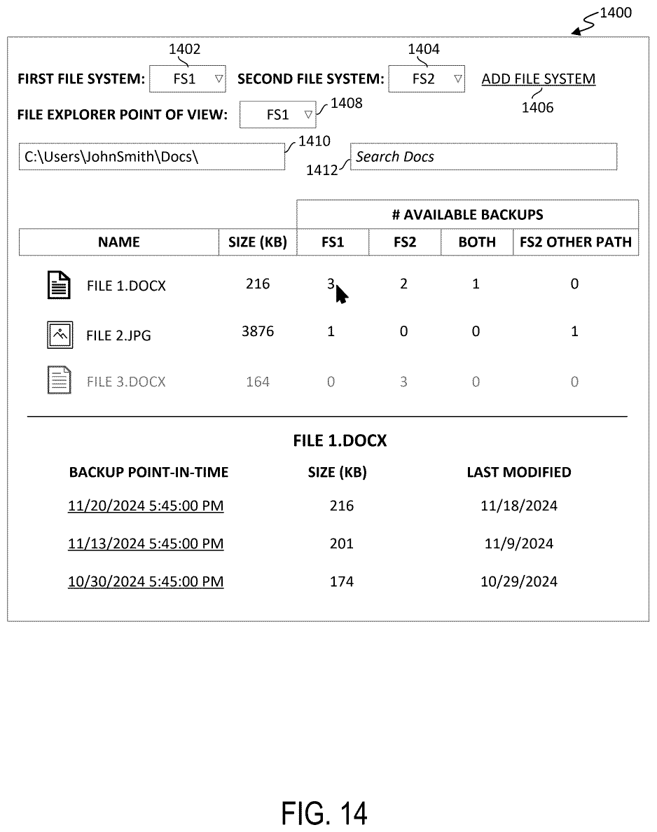

FIG. 14 illustrates a multiple point-in-time file system explorer 1400 for file system comparison, in accordance with any of the embodiments disclosed herein. The multiple point-in-time file system explorer 1400 may include any suitable characteristics of multiple point-in-time file system explorers 402, 600, 1000, or 1100.

Multiple point-in-time file system explorer 1400 includes interfaces 1402 and 1404 to select the first file system and second file system respectively. If one or more additional file systems are to be compared, the user may select the link 1406 which will provide an interface to add a third file system (or any number of additional file systems).

A file system may be specified in any suitable manner. For example, an identifier of a file system may include an identifier (e.g., a universally unique identifier, a network address or other location, a name, etc.) of the file system itself, a computing system that manages the file system, a storage volume that stores the file system, a backup of the file system (whether on-premises or in the cloud), and/or other suitable identifier. In this embodiment, FS1 is used as the identifier for the first file system and FS2 is used as the identifier for the second file system.

Interface 1408 allows a user to select the file system that will be used as the point of view for the multiple point-in-time file system explorer 1400. In other embodiments, the multiple point-in-time file system explorer 1400 could default to the file system specified as the first file system for the point of view or may display results in a manner that omits a point of view (e.g., only the file paths that are common among the file systems being compared may be browsable within the multiple point-in-time file system explorer 1400).

A file path may be input and/or displayed in interface 1410 and/or a search expression may be entered in interface 1412. The file and directory results displayed by the multiple point-in-time file system explorer 1400 may be based on the file path and/or search expression. In this embodiment, a search expression is not entered, and the results shown are based on the file path.

As depicted, the results include FILE 1.DOCX, FILE 2.JPG, and FILE 3.DOCX. In this embodiment, these results represent the files that are present at the path C:\Users\JohnSmith\Docs\ on either of file systems being compared for any of the backups that are available for either of the file systems (directories may additionally be displayed in the results, although this example does not depict any directories at this path).

For each file, any suitable information about the file may be displayed, including its name, extension, size, last modified date (not shown for all files in this example), or other suitable information. At least some of this information may be from the point of view of the version of the file backed up for the file system that is used for the point of view. The multiple point-in-time file system explorer 1400 may also display information about backups available for the file in the various file systems being compared. In this embodiment, the information includes the number of backups that are available at the specified path in the first file system (3 for FILE 1.DOCX, 1 for FILE 2.JPG, and 0 for FILE 3.DOCX), the number of backups that are available at the specified path in the second file system (2 for FILE 1.DOCX, 0 for FILE 2.JPG, and 3 for FILE 3.DOCX), the number of backups identical in content and name that are available at the specified path in both (or all if more than two file systems are being compare) file systems (1 for FILE 1.DOCX, 0 for FILE 2.JPG, and 0 for FILE 3.DOCX), and the number of backups identical in content (and optionally in name) to the corresponding file in the first file system that are available in the second file system, but at a path that is different from the specified path (0 for FILE 1.DOCX, 1 for FILE 2.JPG, and 0 for FILE 3.DOCX).

Although the information about the backups for the files of the file systems is shown in a table format in this embodiment, the information could be shown in other suitable format. For example, the number of backups that are available at the specified path in the first file system may be shown in a first color, the number of backups that are available at the specified path in the second file system may be shown in a second color, the number of backups identical in content and name that are available at the specified path in both file systems may be shown in a third color, and the number of backups identical in content that are available in the second file system, but at a path that is different from the specified path may be shown in a fourth color. Alternatively, different formatting effects (bolding, highlighting, underlining, etc.) could be used to display the different numbers.

In the embodiment depicted, a file (e.g., FILE 3.DOCX) that is present at the specified path for the second file system, but not present in the first file system is displayed. In one embodiment, such files may be displayed in a format that is different from a format used to display files that are present in the first file system. For example, the information shown for FILE 3.DOCX is shown in a light grey font while the information shown for FILE 1.DOCX and FILE 2.JPG is shown in black in order to allow easy differentiation between the files present in the first file system and the files that are not present in the first file system. In other embodiments, only the files (and directories) present at the path (and/or matching the search expression) of the file system that is selected to be the point of view of the file explorer are shown (and files or directories that are present solely on one or more of the other file systems being compared may be omitted). Thus, FILE 3.DOCX would be omitted from the results. In such an embodiment, if the point of view were switched to the second file system, then FILE 3.DOCX would be displayed while FILE 2.JPG would not (as FILE 2.JPG is present in the second file system, but not at the specified path).

The switching of the point of view may also result in a change in the order of the presentation of the information for the results. For example, the results for the second file system may be shown in place of the results for the first file system and vice versa. In some instances, the “OTHER PATH” results for the second file system would be replaced by “OTHER PATH” results for the first file system.

In various embodiments, selection of one of the numbers may result in display of more detailed information about the backups. For example, in the embodiment depicted, a mouse cursor is shown as selecting the 3 backups for FILE 1.DOCX in the first file system. Responsive to this selection, additional information about the backups for FILE 1.DOCX in the first file system are shown. In the embodiment depicted, this additional information includes the points in time of the three backups, along with the sizes of the versions of the file in each of these backups, and the last modified date for the versions of the file in each of these backups.

Selection of the other numbers may result in display of similar information for the other backups. For example, selection of “2” under FS2 for FILE 1.DOCX may result in display of information of the backups for FILE 1.DOCX for the second file system. As another example, selection of 1 under BOTH for FILE 1.DOCX may display information about the backup of FILE 1.DOCX for the first file system as well as the equivalent backup (having the same file contents) of FILE 1.DOCX for the second file system (while the point in time of the backup may be different). Selection of 1 under FS2 OTHER PATH for FILE 2.JPG may display information of the backup of FILE 2.JPG for the second file system (e.g., including the same information and/or the alternative path of the second file system at which FILE 2.JPG is located). As yet another example, selection of 3 under FS2 for FILE 3.DOCX may display information of the backup of FILE 3.DOCX for the second file system.

In other embodiments, the additional information, any other suitable information about the backups of the files, and/or subsets of the information may be displayed in any suitable sequence or at any suitable time by multiple point-in-time file system explorer 1400. For example, once a file path is entered, information about the backups (e.g., the points in time) of the backups could be individually displayed (e.g., rather than waiting until a number of backups is selected). As another example, right clicking a file name or a number of backups may result in display of information about the backups. Any other suitable arrangements of displaying information about the backups is contemplated by this disclosure.

In various embodiments, the multiple point-in-time file system explorer 1400 may also include options to view and/or restore the files from the particular point-in-time displayed for a backup. For example, in the embodiment depicted, a user may click one of the points in time for FILE 1.DOCX. The version of FILE 1.DOCX may then be accessed and displayed or previewed to the user and/or the user may be presented with an option to restore that version of FILE 1.DOCX.

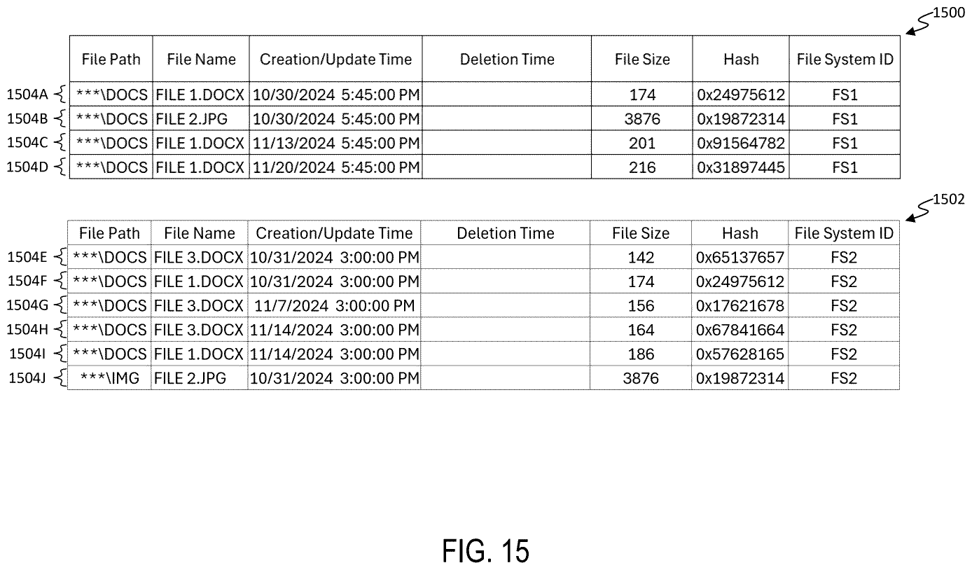

FIG. 15 illustrates a storage backup log 1500 and a storage backup log 1502 for a multiple point-in-time file system explorer for file system comparison, in accordance with any of the embodiments disclosed herein. The storage backup logs 1500 and 1502 may have any suitable characteristics of the other storage backup logs described herein. The storage backup log 1500 includes the records 1504 for the first file system and the storage backup log 1502 includes the records 1504 for the second file system. In other embodiments, a storage backup log may combine records for the two file systems (and other file systems), whether part of the same backup series or for different backup series (even for different computing systems). In various embodiments, a representation of the multiple point-in-time file system explorer 1400 may be constructed (e.g., by the data backup and search system 108 or other suitable logic of cloud data backup environment 100) based on the information included within one or more storage backup logs (e.g., 1500, 1502).

Referring jointly to FIG. 14 and FIG. 15, the three backups for FILE 1.DOCX of the first file system are captured in records 1504A, 1504C, and 1504D (in the embodiment depicted, the *** in the file path column represents C:\Users\JohnSmith for purposes of this example). These records include the points in time of the backups in the creation/update time column of the storage backup log 1500, the same points in time that are displayed by multiple point-in-time file system explorer 1400 for the backups. Similarly, these records include the sizes of the different versions of FILE 1.DOCX that are displayed by storage backup log 1500.

The two backups for FILE 1.DOCX of the second file system are captured in records 1504F and 1504I. Within the records for FILE 1.DOCX, the respective hashes indicate that the version of the file corresponding to record 1504A for the first file system (with hash value 0x24975612) is identical to the version of the file corresponding to record 1504F for the second file system (also with hash value 0x24976512) (e.g., the contents of the different versions are identical). Accordingly, the multiple point-in-time file system explorer 1400 indicates that there is one available backup for FILE 1.DOCX in both of the file systems.

Record 1504B corresponds to the single available backup for the first file system for FILE 2.JPG. Record 1504J corresponds to the backup for FILE 2.JPG that is at another path (C:\Users\JohnSmith\IMG\) of the second file system. The identical nature of the hashes of record 1504B and 1504J confirms that the backup is the same version of FILE 2.JPG despite being in different paths (as opposed to a similarly named file in a different path). In various embodiments, the system may also consider a file in a different path of the second file system to be the same as a file in the specified path if the files have different names but the same hash value.

As described above, a hash comparison of contents of the files is used to determine whether a backup of a file in a first file system is identical to a backup of the file in a second file system (whether in the same path on the second file system or in a different path). In other embodiments, when the files are in the same paths on different file systems, any one or more of the names, sizes, creation times, and last modified dates of the files may be compared against each other and if they are equivalent the backups of the file are determined to be the same.

Embodiments not utilizing the hash may in some instances be less computationally intensive for the determinations. In some embodiments, the determination of whether backups exist for a file in the second file system (or other additional file systems) but that are not in the same path as in the first file system is not performed for all files. For example, such a determination may be performed only for files for which the user specifically requests the determination (e.g., after the files are displayed in multiple point-in-time file system explorer 1400). As another example, such a determination may be performed for only a subset of the files that are displayed (e.g., only non-common files as described below or other file types specified by the user).

Records 1504E, 1504G, and 1504H correspond to the three backups for FILE 3.DOCX for the second file system.

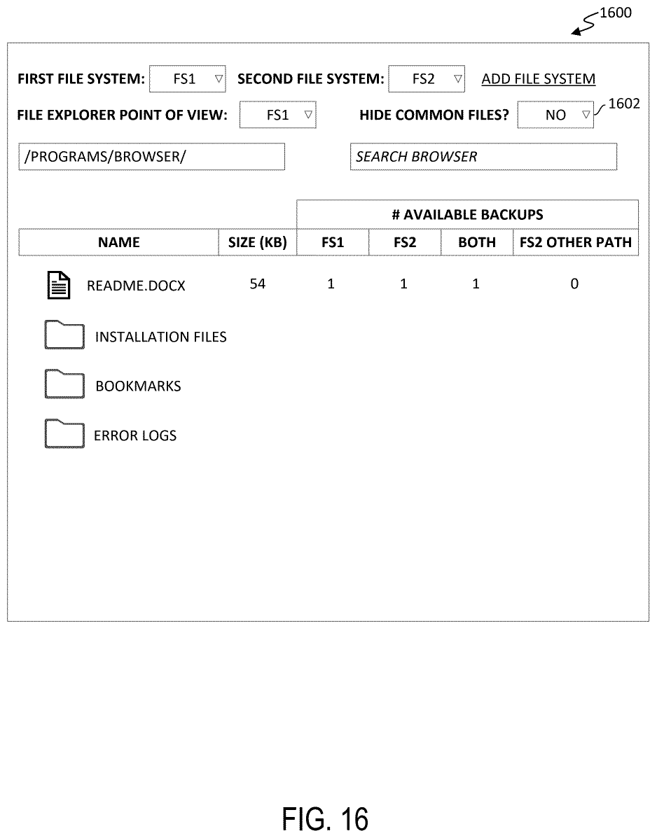

FIG. 16 illustrates a multiple point-in-time file system explorer 1600 for file system comparison including an option to hide common files, in accordance with any of the embodiments disclosed herein. The multiple point-in-time file system explorer 1600 may include any suitable characteristics of multiple point-in-time file system explorers 402, 600, 1000, 1100, or 1400.

The multiple point-in-time file system explorer 1600 is generally similar to multiple point-in-time file system explorer 1400, but also includes an interface 1602 that allows the user to hide common files. In this embodiment, the interface 1602 is set to not hide common files, but when the user opts to hide common files, then files that are designated as common are not displayed in the multiple point-in-time file system explorer 1600. In some embodiments, directories that only include common files may also be hidden (or displayed with an indication that the directory only includes common files) in the multiple point-in-time file system explorer 1600.

In other embodiments, the multiple point-in-time file system explorer 1400 or multiple point-in-time file system explorer 1600 may include indications of whether the files displayed are common files and/or whether the files are not common files. Hiding the common files or displaying indications of the common files may help a user more quickly find the interesting files in the system during browsing of the file system comparisons.

The path in the depicted embodiment is set to /PROGRAMS/BROWSER/ and the results shown represent files and directories of a fictitious application called “browser.” In this example, the file README.DOCX may be considered a common file (e.g., this file may be the same for all installations of the application). The directory INSTALLATION FILES may include standard installation files that do not vary in content across installations on different machines and thus could be considered to include only common files. Accordingly, if the interface 1602 were set to hide the common files, the results may exclude the README.DOCX and the INSTALLATION FILES directory and thus would only include the BOOKMARKS and the ERROR LOGS directories (which may include files that may vary from machine to machine and thus are not designated as common files.

The data backup and search system 108 or other suitable logic of the cloud data backup environment 100 may determine whether a file is a common file in any suitable manner. For example, the data backup and search system 108 may maintain a table of common files (e.g., with records including paths, file names, sizes, and/or hashes of the files that may be compared against records of storage backup logs to determine whether files under consideration are common files. In various embodiments, a match of one or more of the file path, the file name, the size, or the hash of a file referenced in a storage backup log to a file path, file name, size, or hash in the table may result in designation of the file as common. Such a table could be built by the data backup and search system 108, e.g., based on the frequency at which files with any one or more of these values appear in backups processed by the 108 or based on other suitable information. In other embodiments, a bloom filter may be used to determine whether a file is a common file.

In various embodiments, in order to facilitate the quick determination of identical copies of files on backups of different file systems during provision of the file explorer, links between the copies may be maintained. For example, records for backups of multiple file systems may be aggregated in the same database and the hash column may be indexed such that all records with a particular hash value may be located more quickly during the determination of whether backups exist on each of these file systems.

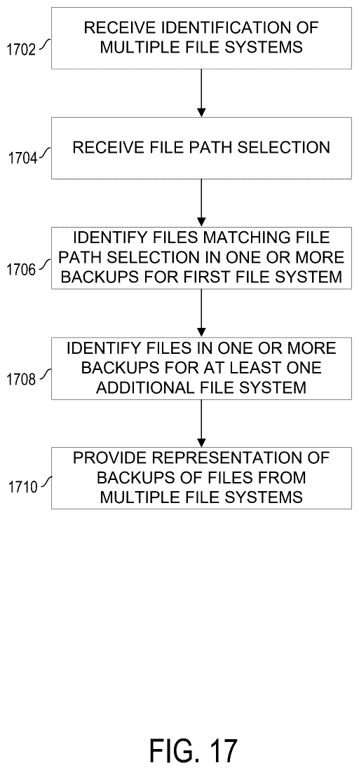

FIG. 17 illustrates a flow for providing a multiple point-in-time file system explorer for file system comparison, in accordance with any of the embodiments disclosed herein. Operations of the flow may be performed by the data backup and search system 108, backup engine 110, a backend 106, one or more computing devices 102, other suitable logic, and/or a combination thereof.

At 1702, identification of multiple file systems to compare may be received. For example, a user of a computing device 102 may enter identifications via a web interface providing a file explorer or via other suitable means. The identifications may be transmitted over a network to data backup and search system 108 or other suitable logic that is to provide functionality of multiple point-in-time file system explorer 1400 or multiple point-in-time file system explorer 1600. In some embodiments, the identification of multiple file systems may include the identification of two file systems. In other embodiments, the identification of multiple file systems may include the identification of more than two file systems.

At 1704, a file path selection is received. For example, the user may enter the file path selection via an interface in the file explorer. The file path selection may be transmitted over network 104 to the data backup and search system 108 or other logic providing the file explorer.

At 1706, files matching the file path selection in one or more backups for a first file system of the multiple file systems are identified. For example, a storage backup log with records indicating changes to files in various backups of a storage collection may be searched to identify files having a path matching the file path selection.

At 1708, files in one or more backups for at least one additional file system of the multiple file systems are identified. Such files may include, e.g., files of one or more file systems that match the file path and/or files of the one or more file systems that have contents identical to the files identified for the first file system (e.g., such a file may have a hash value that matches a hash value of a file identified for the first file system).

At 1710, a representation of backups of files from multiple file systems is provided. For example, such a representation may include any of the information depicted in multiple point-in-time file system explorer 1400 or multiple point-in-time file system explorer 1600 or other suitable information about the versions in backups of the multiple file systems. The representation may have any suitable format, such as those described above with respect to representations provided for the other file explorers, or any other suitable representation.

It is important to note that the operations in FIGS. 7-8, 12-13, and 17 illustrate only some of the possible scenarios that may be executed by, or within, the various components of the systems described herein. Some of these operations may be removed or repeated where appropriate, or these steps may be modified or changed considerably without departing from the scope of the present disclosure. In addition, the timing of these operations may be altered considerably. The preceding operational flows have been offered for purposes of example and discussion.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

What is claimed is:

1. A method, comprising:
receiving a request to view a portion of a first file system and a second file system; and
generating a representation of a portion of a first file system and a second file system, the representation displayable in a file system explorer, wherein the representation includes a file at a file path, a first indication of one or more backups of the file for the first file system, and a second indication of one or more backups of the file for the second file system.

2. The method of claim 1, wherein the representation includes an indication of a first number of backups available for the file for the first file system and a second number of backups available for the file for the second file system.

3. The method of claim 1, wherein the representation includes an indication of a number of backups available for the file for the first file system that have identical contents as backups available for the file for the second file system.

4. The method of claim 1, wherein the representation includes a plurality of points in time of backups of the file for the first file system.

5. The method of claim 1, wherein the representation is based on a point of view of the first file system responsive to a selection of the point of view by a user.

6. The method of claim 1, wherein the one or more backups of the file for the second file system match the file path.

7. The method of claim 1, wherein the one or more backups of the file for the second file system do not match the file path.

8. The method of claim 1, further comprising:
determining whether the file is a common file; and
displaying the first indication and second indication responsive to a determination that the file is not a common file.

9. The method of claim 1, further comprising generating the first indication and the second indication based on a search of one or more storage backup logs.

10. The method of claim 9, further comprising storing the one or more storage backup logs in one or more relational databases, wherein a record of the one or more relational databases includes a point-in-time and corresponds to a change to the file for a storage backup performed at that point-in-time.

11. An apparatus comprising:
a communication interface to receive a request for a portion of a first file system and a second file system; and
at least one processor to generate a representation of a portion of a first file system and a second file system, the representation displayable in a file system explorer, wherein the representation includes a file at a file path, a first indication of one or more backups of the file for the first file system, and a second indication of one or more backups of the file for the second file system.

12. The apparatus of claim 11, wherein the representation includes an indication of a first number of backups available for the file for the first file system and a second number of backups available for the file for the second file system.

13. The apparatus of claim 11, wherein the representation includes an indication of a number of backups available for the file for the first file system that have the same contents as backups available for the file for the second file system.

14. The apparatus of claim 11, wherein the representation includes a plurality of points in time of backups of the file for the first file system.

15. The apparatus of claim 11, wherein the representation includes a plurality of points in time of backups of the file for the first file system and the second file system.

16. At least one computer-readable non-transitory media comprising one or more instructions that when executed by at least one processor configure the at least one processor to cause performance of operations comprising:
receiving a request to view a portion of a first file system and a second file system; and
generating a representation of a portion of a first file system and a second file system, the representation displayable in a file system explorer, wherein the representation includes a file at a file path, a first indication of one or more backups of the file for the first file system, and a second indication of one or more backups of the file for the second file system.

17. The at least one media of claim 16, wherein the representation includes an indication of a first number of backups available for the file for the first file system and a second number of backups available for the file for the second file system.

18. The at least one media of claim 16, wherein the representation includes an indication of a number of backups available for the file for the first file system that have the same contents as backups available for the file for the second file system.

19. The at least one media of claim 16, wherein the representation includes a plurality of points in time of backups of the file for the first file system.

20. The at least one media of claim 16, wherein the representation includes a plurality of points in time of backups of the file for the first file system and the second file system.
